(19) United States
(12) Patent Application Publication
(10) Pub. No.: US 2023/0099749 A1
(43) Pub. Date: Mar. 30, 2023

(54) SALES ASSISTANCE SYSTEM, SALES ASSISTANCE METHOD, AND PROGRAM RECORDING MEDIUM

(71) Applicant: NEC Corporation, Minato-ku, Tokyo (JP)

(72) Inventor: Ryosuke TOGAWA, Tokyo (JP)

(73) Assignee: NEC Corporation, Minato-ku, Tokyo (JP)

(21) Appl. No.: 17/802,999

(22) PCT Filed: Mar. 27, 2020
(86) PCT No.: PCT/JP2020/013914

§ 371 Date: Aug. 29, 2022

(51) Int. Cl. G06Q 30/0202

(52) U.S. Cl. CPC G06Q 30/0202

(57) ABSTRACT

A sales assistance system is configured to comprise an acquisition unit and a prediction unit. The acquisition unit acquires: sales process time series data indicating the time series sequence of a plurality of actions included in sales activity for a target customer at a first time point; and customer attribute data of the target customer. The prediction unit predicts a sales activity action for the target customer subsequent to the first time point, and a probability of success of the sales activity for the target customer if an action is taken based on the sales process time-series data and the customer attribute data by using a prediction model.

### TECHNICAL FIELD

The present invention relates to a technology for predicting an action recommended in a sales activity, and more particularly, to a technology for predicting an action for increasing the possibility of securing a contract.

### BACKGROUND ART

Sales assistance systems that support marketing and sales activities have been widely used. Such a sales assistance system may have a function of presenting a proposal of a method for approaching customers may be provided. For example, a technology as disclosed in PTL 1 is disclosed as a technology for presenting the proposal of the method for approaching customers.

PTL 1 relates to a technology for presenting a new customer and a new sales method based on a trained model generated based on historical results. A trained model generation device of PTL 1 estimates a segment to which a new customer belongs based on a trained model, and presents an approach method according to the segment. PTL 2 discloses a sales activity assistance system that calculates a success probability based on an operation record of a maintenance target, and PTL 3 discloses a sales activity assistance system that predicts a success probability according to an attribute or the like of a partner candidate.

### CITATION LIST

### Patent Literature

### [PTL 1] JP 2016-118865 A

### [PTL 2] JP 2016-62382 A

### [PTL 3] JP 2019-79302 A

### SUMMARY OF INVENTION

### Technical Problem

However, the technologies of PTL 1, PTL 2, and PTL 3 cannot present to a customer who has already started a sales activity what kind of sales activity should be performed after the current time point.

An object of the present invention is to provide a sales assistance system, a sales assistance method, and a program recording medium capable of assisting in improving a probability of success of a sales activity, increasing sales, improving efficiency of the sales activity, and the like by predicting an action after the current time point necessary for increasing a possibility of securing a contract, in order to solve the above problems.

### Solution to Problem

In order to solve the above problems, a sales assistance system of the present invention includes an acquisition unit and a prediction unit. The data acquisition unit acquires sales process time-series data indicating a time-series order of a plurality of actions included in a sales activity for a target customer at a first time point, and customer attribute data regarding an attribute of the target customer. The prediction unit predicts an action of the sales activity for the target customer after the first time point, and a probability of success of the sales activity for the target customer in a case where the action after the first time point is performed, by using a prediction model, the sales process time-series data, and the customer attribute data acquired by the acquisition unit. The prediction model is generated by machine learning using a plurality of pieces of sales process time-series data at time points before the first time point, a plurality of pieces of customer attribute data regarding attributes of a plurality of customers for which a sales activity related to the plurality of pieces of sales process time-series data has been performed, and a result of the sales activity for each of the plurality of customers.

A sales assistance method of the present invention includes acquiring sales process time-series data indicating a time-series order of a plurality of actions included in a sales activity for a target customer at a first time point, and customer attribute data regarding an attribute of the target customer. The sales assistance method of the present invention includes predicting an action of the sales activity for the target customer after the first time point, and a probability of success of the sales activity for the target customer in a case where the action after the first time point is performed, by using a prediction model, the sales process time-series data, and the customer attribute data. The prediction model is generated by machine learning using a plurality of pieces of sales process time-series data at time points before the first time point, a plurality of pieces of customer attribute data regarding attributes of a plurality of customers for which a sales activity related to the plurality of pieces of sales process time-series data has been performed, and a result of the sales activity for each of the plurality of customers.

A program recording medium of the present invention records a sales assistance program. The sales assistance program causes a computer to perform processing of acquiring sales process time-series data indicating a time-series order of a plurality of actions included in a sales activity for a target customer at a first time point, and customer attribute data regarding an attribute of the target customer. The sales assistance program causes a computer to perform processing of predicting an action of the sales activity for the target customer after the first time point, and a probability of success of the sales activity for the target customer in a case where the action after the first time point is performed, by using a prediction model, the sales process time-series data, and the customer attribute data. The prediction model is generated by machine learning using a plurality of pieces of sales process time-series data at time points before the first time point, a plurality of pieces of customer attribute data regarding attributes of a plurality of customers for which a sales activity related to the plurality of pieces of sales process time-series data has been performed, and a result of the sales activity for each of the plurality of customers.

### Advantageous Effects of Invention

According to the present invention, it is possible to suitably support sales activities. For example, it is possible to improve a probability of success of a sales activity, increase sales, improve efficiency of the sales activity, and the like by predicting an action after the current time point necessary for increasing a possibility of securing a contract.

### BRIEF DESCRIPTION OF DRAWINGS

FIG. 1 is a diagram illustrating a configuration of a sales assistance system according to a first example embodiment of the present invention.

FIG. 2 is a diagram illustrating a configuration of a prediction model generation device according to the first example embodiment of the present invention.

FIG. 3 is a diagram schematically illustrating an example of a graph according to the first example embodiment of the present invention.

FIG. 4 is a diagram illustrating a configuration of a prediction device according to the first example embodiment of the present invention.

FIG. 5 is a diagram illustrating an operation flow of the prediction model generation device according to the first example embodiment of the present invention.

FIG. 6 is a diagram illustrating an example of input data according to the first example embodiment of the present invention.

FIG. 7 is a diagram illustrating an example of input data according to the first example embodiment of the present invention.

FIG. 8 is a diagram illustrating an example of input data according to the first example embodiment of the present invention.

FIG. 9 is a diagram illustrating an operation flow of the prediction device according to the first example embodiment of the present invention.

FIG. 10 is a diagram illustrating an example of a prediction result according to the first example embodiment of the present invention.

FIG. 11 is a diagram illustrating a configuration of a sales assistance system according to a second example embodiment of the present invention.

FIG. 12 is a diagram illustrating an operation flow of the sales assistance system according to the second example embodiment of the present invention.

FIG. 13 is a diagram illustrating an example of another configuration according to the present invention.

### EXAMPLE EMBODIMENT

### First Example Embodiment

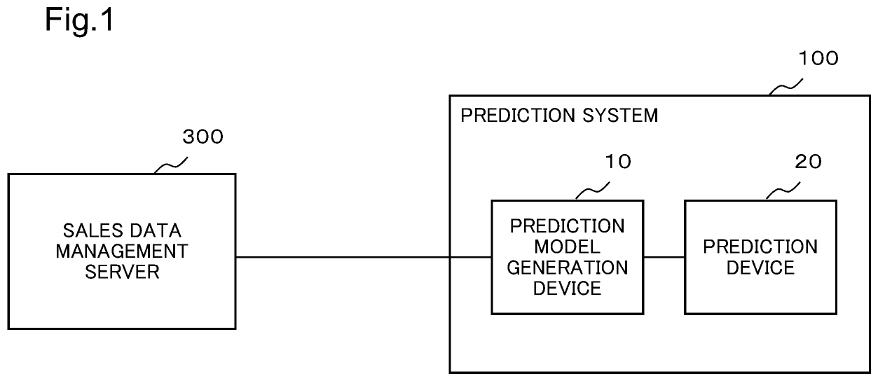

Hereinafter, a first example embodiment of the present invention will be described in detail with reference to the drawings. FIG. 1 is a diagram illustrating an outline of a configuration of a sales assistance system according to the present example embodiment. The sales assistance system of the present example embodiment includes a prediction system 100 and a sales data management server 300. The prediction system 100 and the sales data management server 300 are connected via a network.

The sales assistance system according to the present example embodiment is a system that predicts, by using a prediction model, a sales process after a prediction time point at which a possibility of securing a contract is high, based on an activity history of a sales activity already performed before the current time point, that is, the prediction time point. The sales process refers to a time-series order of a series of actions performed from when the first action of a sales activity for a customer is performed until a result indicating success or failure in securing a contract is output. The sales process may include approaches and actions for customers at the marketing stage. The action refers to an individual sales action performed by a sales representative for a customer. Example of the action include, but are not limited to, holding a seminar for customers, making a phone call to customers, sending a mail magazine to customers, interviewing customers, visiting customers, discussing with customers, negotiating and counseling with customers (including price negotiation and product proposal), demonstrating a product or system for customers, exhibition invitation, a tour of a plant, and a social gathering with customers, and include any action performed as part of general sales activities.

The sales assistance system according to the present example embodiment is not limited to a sales process having a high possibility of securing a contract, and can predict a sales process including an action to be performed after the current time point. For example, the sales assistance system according to the present example embodiment can predict a sales process including an action having a low possibility of securing a contract. As a result, a sales representative can be educated. Hereinafter, in the present specification, the “sales process having a high possibility of securing a contract” is used as a term also meaning “a sales process including an action to be performed after the current time point” or “a sales process including an action having a low possibility of securing a contract”.

The prediction system 100 includes a prediction model generation device 10 and a prediction device 20. The prediction model generation device 10 and the prediction device 20 are connected via a network. The prediction model generation device 10 and the prediction device 20 may be formed as an integrated device. The functions of units included in the prediction model generation device 10 and the prediction device 20 may be implemented by different devices.

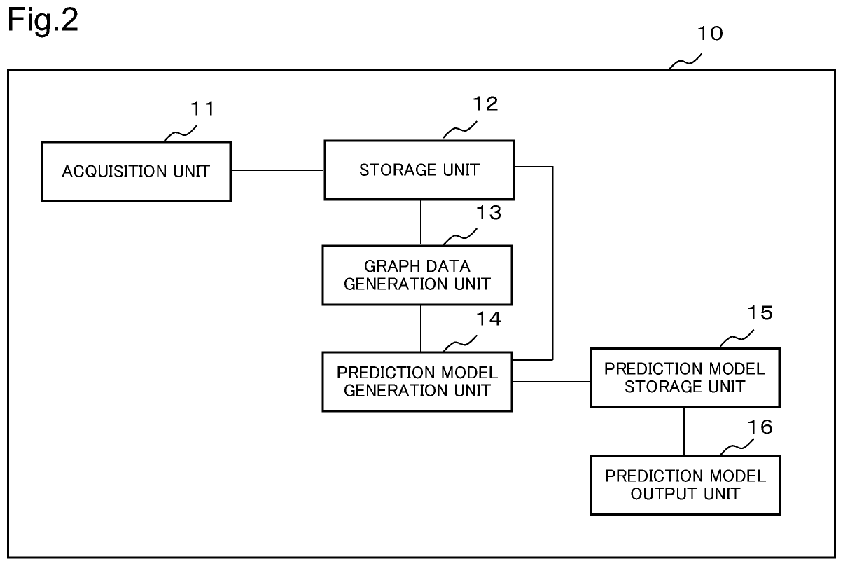

A configuration of the prediction model generation device 10 will be described. FIG. 2 is a diagram illustrating a configuration of the prediction model generation device 10. The prediction model generation device 10 includes an acquisition unit 11, a storage unit 12, a graph data generation unit 13, a prediction model generation unit 14, a prediction model storage unit 15, and a prediction model output unit 16. The prediction model generation device 10 is a device that generates a prediction model to be used when predicting a sales process after a prediction time point at which a possibility of securing a contract is high based on an activity history of an already performed sales activity.

The acquisition unit 11 acquires data to be used for generating the prediction model. The acquisition unit 11 acquires, as the data to be used for generating the prediction model, identification information of a customer who was a target of the sales activity in the past, an attribute of the customer, and data regarding success or failure in securing a contract. For example, the acquisition unit 11 acquires data of a company name of the customer as the identification information of the customer, and acquires data of the type of business of the customer as the attribute of the customer.

The acquisition unit 11 acquires, from the sales data management server 300, activity history data for each case from the first approach to a customer to confirmation of a result indicating success or failure in securing a contract, for the past sales activity. The activity history data includes information on an action performed in the sales activity for each case and a date and time when each action has been performed. That is, the activity history data is data indicating a time-series order of a plurality of actions performed in the sales activity.

Hereinafter, in the present specification, the “activity history data” is also referred to as “sales process time-series data”.

The storage unit 12 stores each data input from the acquisition unit 11.

The graph data generation unit 13 generates, as graph structure data, a graph showing a sales process related to the sales process time-series data based on the sales process time-series data. The graph generated by the graph data generation unit 13 includes nodes indicating actions in the sales activity and edges indicating an order relation between the actions in the sales activity. The graph structure data indicates the time-series order of the actions in the sales activity. Specifically, in the graph structure data, the length of an edge included in the graph structure data can indicate the order of and a time interval between actions represented by nodes at opposite ends of the edge. In a case where there is no edge between nodes in the graph, there is no order relation between actions represented by the nodes. That is, an edge included in the graph structure is not provided between nodes representing actions having no order relation. Therefore, the graph structure data indicates the sales process. The action in the sales activity may include an action in a marketing stage in which the sales activity such as the sale of a specific product is not started.

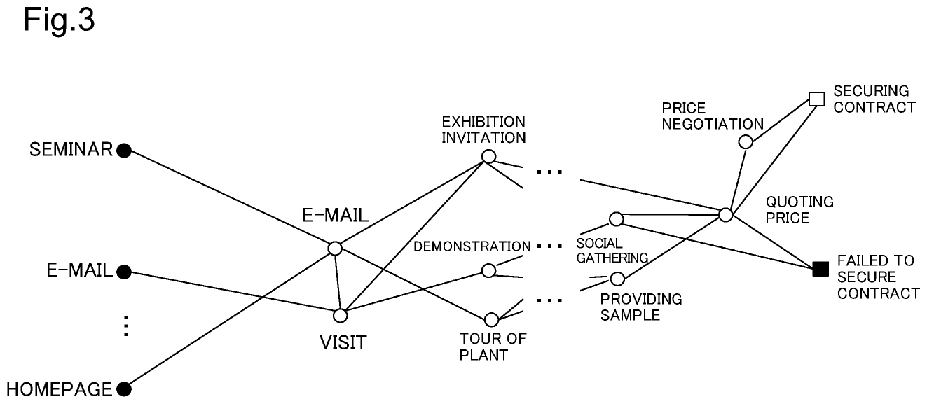

FIG. 3 schematically illustrates an example of the graph generated by the graph data generation unit 13. FIG. 3 illustrates a graph generated based on activity histories of a plurality of cases as one graph. A white circle in FIG. 3 indicates an action in the sales process that is set as a node. A black circle in FIG. 3 indicates the first action for each case, that is, an action when contacting a customer for the first time in the sales activity of a target case. In the sales activity of the target case, an action when contacting a customer for the first time is also referred to as an entry point.

The prediction model generation unit 14 generates the prediction model for predicting a sales process having a high possibility of securing a contract based on the graph structure data, attribute data related to nodes included in the graph, and a label indicating success or failure of the sales activity. The prediction model generation unit 14 generates the prediction model by machine learning using the graph structure data generated based on the activity history, the type of business of the customer as training data, and success or failure in securing a contract as a result of the sales activity as a label. The prediction model generation unit 14 generates the prediction model by calculating a feature amount of the graph by machine learning using a neural network (NN) or deep learning. The prediction model may be generated using any machine learning method such as supervised learning, unsupervised learning, semi-supervised learning, or reinforcement learning.

The prediction model generation unit 14 generates the prediction model by calculating a feature amount of the graph by a STAR method, for example. In the STAR method, pieces of graph structure data at a plurality of time points are input, and a feature amount of the graph is calculated to generate the prediction model. Details of the STAR method are described in Dongkuan Xu et al., “Spatio-Temporal Attentive RNN for Node Classification in Temporal Attributed Graphs”, Proceedings of the Twenty-Eighth International Joint Conference on Artificial Intelligence (IJCAI-19), [searched on Feb. 27, 2020] Internet <URL: https://www.ijcai.org/Proceedings/2019/0548.pdf>.

The prediction model generation unit 14 may generate the prediction model by calculating the feature amount of the graph by a TGNet method. In the TGNet method, machine learning is performed using dynamic data, static data, and label data as inputs to generate a trained model. Details of the TGNet method are described in Qi Song, et al., “TGNet: Learning to Rank Nodes in Temporal Graphs”, Proceedings of the 27th ACM International Conference on Information and Knowledge Management, p. 97-106.

For example, the prediction model generation unit 14 may generate the prediction model by extracting the feature amount by using a feature amount extraction method such as a Netwalk method and combining a feature amount analysis method such as an InerHAT method. Details of the Netwalk method are described in Wenchow Yu, et al., “NetWalk: A Flexible Deep Embedding Approach for Anomaly Detection in Dynamic Networks”, KDD 2018, p. 2672-2681. Further, details of the InerHAT method are described in Zeyu Li, et al., “Interpretable Click-Through Rate Prediction through Hierarchical Attention”, WSDM 2020: The Thirteenth ACM International Conference on Web Search and Data Mining. Instead of the InerHAT method, a prediction technology such as a gradient boosting method may be used. The prediction model generation unit 14 may generate the prediction model by using another method as long as the method is a method of analyzing graph data and extracting a feature pattern.

The prediction model storage unit 15 stores the prediction model generated by the prediction model generation unit 14.

The prediction model output unit 16 outputs the prediction model stored in the prediction model storage unit 15 to the prediction device 20.

Each processing in the acquisition unit 11, the graph data generation unit 13, the prediction model generation unit 14, and the prediction model output unit 16 is performed by executing a computer program on a central processing unit (CPU). A graphics processing unit (GPU) may be combined with the CPU.

The storage unit 12 and the prediction model storage unit 15 are implemented using, for example, a hard disk drive. The storage unit 12 and the prediction model storage unit 15 may be implemented by a nonvolatile semiconductor storage device or a combination of a plurality of types of storage devices.

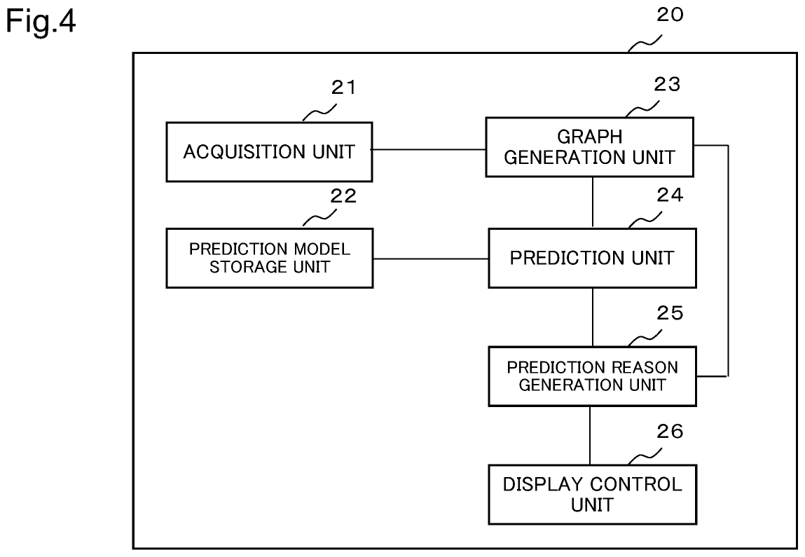

A configuration of the prediction device 20 will be described. FIG. 4 is a diagram illustrating the configuration of the prediction device 20. The prediction device 20 includes an acquisition unit 21, a prediction model storage unit 22, a graph generation unit 23, a prediction unit 24, a prediction reason generation unit 25, and a display control unit 26.

The acquisition unit 21 acquires input data when predicting a sales process having a high possibility of securing a contract by using the prediction model. The acquisition unit 21 acquires, as input data to be used for prediction of a sales process having a high possibility of securing a contract, the data of the activity history of an action of a prediction target sales activity at the current time point, that is, the activity history data of the action performed until the prediction is performed. The acquisition unit 21 acquires the type of business of a target customer as the customer attribute data. The customer attribute data is data regarding the attribute of the target customer, and is not limited to the type of business of the target customer. For example, the customer attribute data is data regarding the type of business, sales, annual profit, the number of employees, purchase performance, a location of a business office or factory, information regarding members, a place of residence, and the like of the customer, but is not limited thereto, and any data may be used as long as the data is data regarding the attribute of the customer. The customer attribute data may be data including at least one of the above-described pieces of information.

The prediction model storage unit 22 stores the prediction model generated by the prediction model generation device 10.

The graph generation unit 23 generates the graph structure data based on the data of the activity history at the current time point. The graph structure data generated based on the activity history includes nodes indicating actions in the sales process and an edge connecting two consecutive actions in the sales process to indicate a time-series order of the actions.

The prediction unit 24 predicts a sales process having a high possibility of securing a contract by using the input data based on the prediction model stored in the prediction model storage unit 22. The prediction unit 24 predicts a sales process having a high possibility of securing a contract by using the prediction model with the graph structure data based on the activity history of the sales activity performed for the target customer so far and the type of business of the target customer in the attribute data associated to the node of the graph structure data as inputs. The sales process having a high possibility of securing a contract refers to information indicating actions after the current time point that can increase a possibility of securing a contract and an order of the actions.

The prediction reason generation unit 25 generates a reason for the prediction performed by the prediction unit 24.

The display control unit 26 controls a display unit (not illustrated) included in the prediction device 20 or a display device outside the prediction device 20 in such a way as to display a prediction result added with the reason for prediction. The display control unit 26 may control the display on the display device by transmitting the prediction result added with the reason for prediction to a terminal of a user who uses the prediction result, but the display control method is not limited thereto. As a result, according to the present invention, it is possible to more suitably support the sales activity by presenting the reason in addition to the action after the current time point to a sales representative.

The display control unit 26 may control the display device to display only the prediction result on the display device. It is also possible to suitably support, with only the display of the prediction result, the sales activity by presenting the reason in addition to the action after the current time point to a sales representative.

Each processing in the acquisition unit 21, the graph generation unit 23, the prediction unit 24, the prediction reason generation unit 25, and the display control unit 26 is performed by executing a computer program on the CPU.

The prediction model storage unit 22 is implemented using, for example, a hard disk drive. The prediction model storage unit 22 may be implemented by a nonvolatile semiconductor storage device or a combination of a plurality of types of storage devices.

In FIG. 1, the sales data management server 300 manages the activity history data for each sales activity. As the activity history data, for example, data input by a sales representative via a terminal device is used. The activity history data may be data extracted from daily sales records. For example, the sales data management server 300 may extract, as the activity history data, “March 2”, which is a date, “X company”, which is a target of the sales activity, and “e-mail” indicating an action in the sales activity from a daily sales record written by a sales representative and indicating “introducing a product A to an X company by e-mail on March 2”. The sales data management server 300 transmits the activity history data to the prediction model generation device 10.

<Learning Phase>

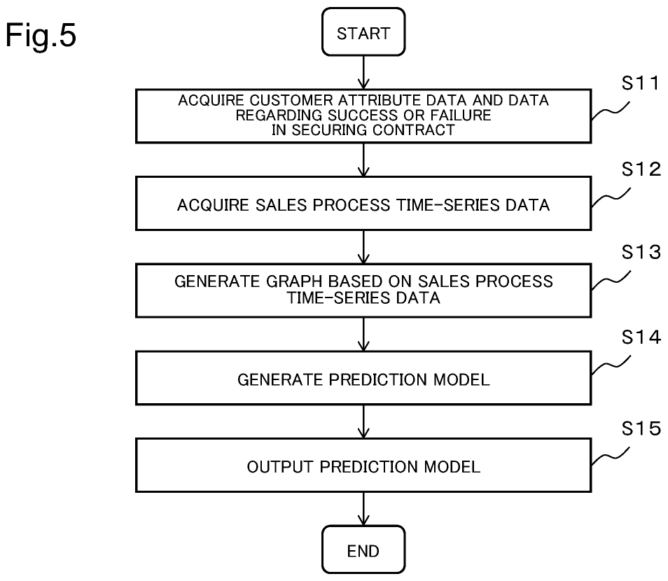

An operation of the sales assistance system according to the present example embodiment will be described. First, an operation when generating the prediction model used for predicting a sales process having a high possibility of securing a contract will be described. FIG. 5 is a diagram illustrating an operation flow when the prediction model generation device 10 generates the prediction model for predicting a sales process having a high possibility of securing a contract.

The acquisition unit 11 acquires the type of business of a target customer in a plurality of sales activities performed in the past used as the attribute data and data regarding success or failure in securing a contract for each sales activity (Step S11). The data regarding success or failure in securing a contract is information indicating success or failure in securing a contract for each sales activity. Each data acquired by the acquisition unit 11 may be input by an operator or may be acquired from another server having each data. The acquisition unit 11 may acquire, from the sales data management server 300, information indicating a result indicating success or failure in securing a contract for each sales activity. Once each data is acquired, the acquisition unit 11 stores each acquired data in the storage unit 12.

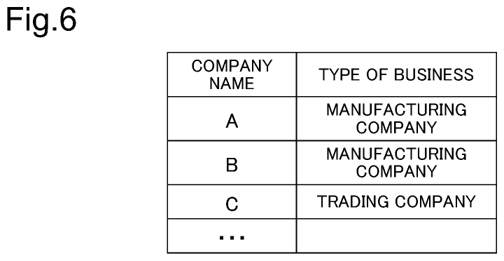

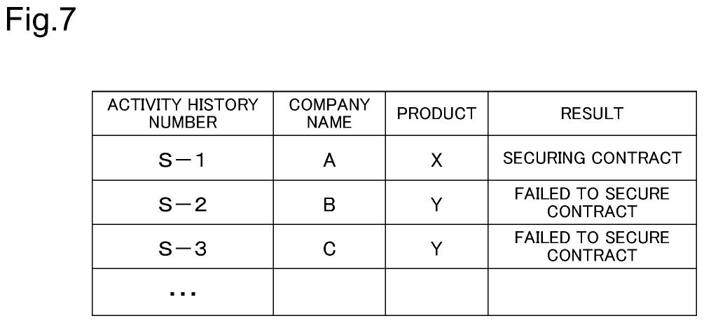

FIG. 6 is a diagram illustrating an example of customer information used as the attribute data. In the example of FIG. 6, the attribute data includes a company name and the type of business of the customer. FIG. 7 is a diagram illustrating an example of the data regarding success or failure in securing a contract used as a label. In the example of FIG. 7, the data regarding success or failure in securing a contract includes an activity history number which is identification information of an activity history, a company name of the customer, products for sale, and a result indicating success or failure in securing a contact.

The acquisition unit 11 acquires, as the sales process time-series data, the activity history data for each sales activity from the sales data management server 300 (Step S12). Once the sales process time-series data is acquired, the acquisition unit 11 stores the acquired sales process time-series data in the storage unit 12.

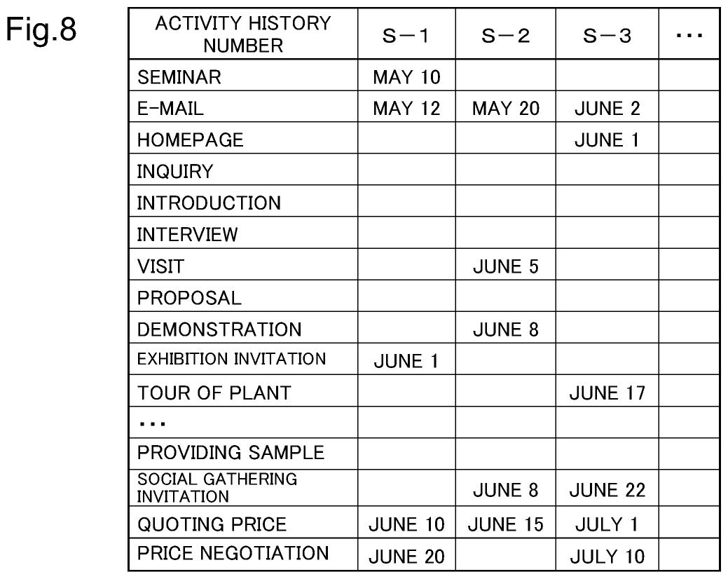

FIG. 8 is a diagram illustrating an example of the sales process time-series data. In the sales process time-series data of FIG. 8, an activity history number which is identification information of an activity history is associated with a date when each action was performed in the sales activity. The activity history number in FIG. 8 corresponds to the activity history number in FIG. 7.

Once the sales process time-series data is stored in the storage unit 12, the graph data generation unit 13 generates the graph structure data based on the sales process time-series data (Step S13). Once the graph structure data is generated, the graph data generation unit 13 transmits the generated graph structure data to the prediction model generation unit 14.

Once the graph structure data is input, the prediction model generation unit 14 reads each data used for generation of the prediction model from the storage unit 12. Once each data is read, the prediction model for predicting a sales process having a high possibility of securing a contract is generated by performing machine learning using the graph structure data based on a plurality of activity histories and the type of business of each of a plurality of customers, which is the customer attribute data, as input data, and using success or failure in securing a contract for each sales activity as a label (Step S14).

Once the prediction model is generated, the prediction model generation unit 14 stores the generated prediction model in the prediction model storage unit 15 as a trained model. Once the prediction model is stored, the prediction model output unit 16 outputs the prediction model to the prediction device 20 (Step S15). The prediction model input to the prediction device 20 is stored in the prediction model storage unit 22.

The prediction model generated by the prediction model generation device 10 may be updated by retraining. For example, the prediction model generation unit 14 updates the prediction model of the prediction model storage unit 15 by performing retraining using data of a graph generated based on a history of an activity performed based on the prediction result, the type of business of the customer as input data, and success or failure in securing a contract as a label of the input data. By performing retraining based on the prediction result in this way, prediction accuracy of the trained model is improved. The prediction model generation unit 14 may newly generate the prediction model by using the input data and the label.

<Prediction Phase>

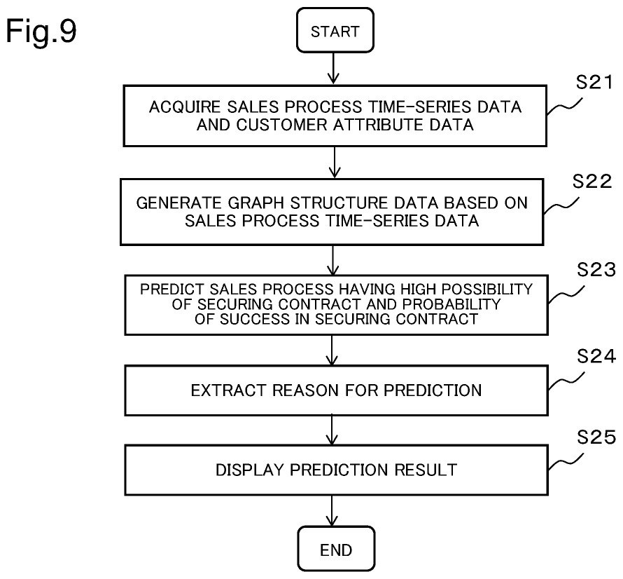

Next, an operation when predicting a sales process having a high possibility of securing a contract in the prediction device 20 will be described. FIG. 9 is a diagram illustrating an operation flow when the prediction device 20 predicts a sales process having a high possibility of securing a contract by using the prediction model.

The acquisition unit 21 acquires the sales process time-series data indicating a history of a prediction target sales activity performed before the current time point, and the customer attribute data including the type of business of a customer for which the sales activity has been performed (Step S21). Once the acquisition unit 21 acquires the sales process time-series data and the customer attribute data, the graph generation unit 23 generates the graph structure data based on the sales process time-series data before the current time point (Step S22). Once the graph structure data is generated, the graph generation unit 23 transmits the generated graph structure data and the data of the type of business of the prediction target customer to the prediction unit 24. Once the graph structure data of the activity history is received, the prediction unit 24 uses the prediction model stored in the prediction model storage unit 22 to predict a sales process having a high possibility of securing a contract and a probability of success in securing a contract by using the graph structure data of the activity history and the type of business of the target customer as the attribute data as inputs (Step S23). Once a sales process having a high possibility of securing a contract is predicted, the prediction unit 24 transmits data of the sales process having a high possibility of securing a contract and the probability of success in securing a contract as a prediction result to the prediction reason generation unit 25. The probability of success is calculated based on a similarity between actions performed before the current time point and each candidate and a contract securing result of each candidate. The prediction result includes data of the sales process having a high possibility of securing a contract, information of an edge that more greatly contributes to securing a contract than other edges, and information of the probability of success.

Once the prediction result is received, the prediction reason generation unit 25 extracts a reason for the prediction (Step S24). The reason for the prediction is information for presenting the reason for the prediction performed by the prediction unit 24 to a user. For example, the prediction reason generation unit 25 extracts an edge that greatly contributes to success in securing a contract from the data of the sales process included in the prediction result, determines that actions associated to nodes at opposite ends of the extracted edge are important actions for securing a contract, and presents the fact that the actions are included as the reason for the prediction.

Once the reason for the prediction is extracted, the prediction reason generation unit 25 outputs the reason for the prediction to the display control unit 26.

Once the prediction result and the reason for the prediction are received, the display control unit 26 controls the display device to display the prediction result and the reason for the prediction on the display device (Step S25). The display control unit 26 may control transmission of data regarding the prediction result and the reason for the prediction to a terminal of a user who uses the prediction result in such a way that the prediction result and the reason for the prediction are displayed on the display device of the terminal of the user.

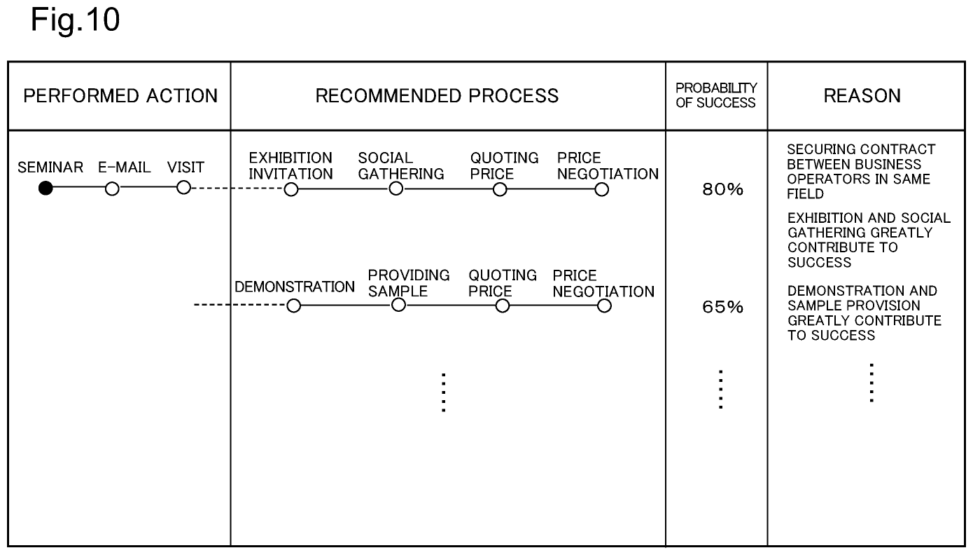

FIG. 10 is a diagram illustrating an example of display data of the prediction result. The display data of the prediction result in FIG. 10 includes a performed action indicating an activity history before the prediction time point, candidates of a recommended process indicating actions to be performed in the future and the order thereof, a probability of success, and a reason why the candidates of each recommended process has been selected. The probability of success is calculated based on a similarity between actions performed before the current time point and each candidate and a contract securing result of each candidate, and is an index indicating a possibility of securing a contract. FIG. 10 illustrates an example in which there are a plurality of candidates of a sales process having a high possibility of securing a contract as the prediction result.

The candidate in the uppermost row of FIG. 10 indicates that the reason for the prediction that the possibility of securing a contract is high is that performance in securing a contract between business operators in the same field is high and that performing an exhibition and a social gathering in this order contributes greatly to success in securing a contract. As a plurality of sales process candidates and a reason when it is predicted that a possibility of securing a contract is high are presented as the prediction result in this manner, a user of the prediction result can select a sales process to be applied to the target customer with reference to the reason for the prediction. FIG. 10 illustrates a plurality of candidates of a sales process having a high possibility of securing a contract. For example, in a case where the sales process shown in the uppermost row is a first prediction result, a sales process having the second highest probability of success in securing a contract following the first prediction result is shown as a second prediction result in the second uppermost row.

As the reason for the prediction, the name of the attribute data used for the prediction may be used as it is. For example, in a case where the fact that the type of business of the customer is manufacturing business greatly contributes to the prediction result, the prediction reason generation unit 25 may extract, for example, the fact that the type of business of the customer is manufacturing business as the reason for the prediction. The prediction reason generation unit 25 may present the reason for the prediction based on a template defined in advance. For example, the prediction reason generation unit 25 may hold a template of the reason for the prediction such as “it is a sales process suitable for a customer of XX”, and generate the reason for the prediction that “it is a sales process suitable for a customer in manufacturing business” in a case where a probability of success in securing a contract is high when the type of business is “manufacturing business” based on the template.

When displaying the prediction result as illustrated in FIG. 10, an action indicated by a node may be displayed (pop-up display) only when a mouse cursor is placed (positioned) on the node on the display screen. The action indicated by the node may be displayed when a portion of the node on the display screen is clicked or tapped. A sales process having a high possibility of securing a contract or an action that greatly contributes to success in securing a contract may be displayed on the screen in a highlighted manner. The display in a highlighted manner is performed, for example, by using bold lines, bold text, color, flash effect, or the magnitude of motion in animation display. As a result, it is possible to improve visibility to a user.

In the above description, the edge of the graph structure data used for generating the prediction model indicates only the order of the actions, but the length of time between the actions may be included in the edge. That is, the graph generation unit 23 can generate the graph structure data in which an edge includes information on the length of time between actions. In this manner, by performing prediction using the prediction model generated using the graph structure data in which an edge includes information on the length of time between actions, it is possible to predict an appropriate timing at which each action is to be performed. When displaying the prediction result as illustrated in FIG. 10, in a case where the cursor is placed on an edge on the display screen, a time interval indicated by the edge, that is, a time interval between actions may be displayed. Further, a time interval indicated by an edge may be displayed in a case where the edge is clicked or tapped on the display screen. As a result, it is possible to improve a probability of success of a sales activity and improve efficiency by presenting an appropriate timing to perform each predicted action to a user such as a sales representative.

In the above description, when generating the prediction model, the information on the type of business of the customer for which the sales activity is performed is used as the attribute data, but the customer attribute data does not have to be used as the input data. In a case where the type of business of the customer that is the customer attribute data is not used as an input when generating the prediction model, the prediction of a sales process having a high possibility of securing a contract is performed only based on the activity history before the prediction time point and a similarity with a sales process having a high probability of success in securing a contract in the past sales activity.

For the customer attribute data when generating the prediction model and performing prediction, instead of the information on the type of business of the customer, information on one or more of attributes of the customer such as the type of business, sales, annual profit, the number of employees, purchase performance, a location of a business office or factory, family members, and a place of residence may be used as the input data. The customer attribute data may be used in addition to the customer attribute data indicating the type of business of the customer.

For the attribute data when generating the prediction model and performing prediction, instead of the customer attribute data, information on one or more of attributes of a company or sales representative that is a target of the sales activity, such as a classification of a product or service for sale, a product or service for sale, sales of a target customer, a sales representative, the position of a sales representative, and a rank of a sales representative may be used as the input data. The attribute data may be used in addition to the customer attribute data. In a case where the attribute data of a customer or a sales representative who is a target of the sales activity is used for generation of the prediction model, the attribute data can be used as an input also at a prediction stage.

The reason for the prediction may include, instead of the order of two actions included in a sales process, at least one of the type of business, sales, annual profit, the number of employees, purchase performance, a classification of a product or service for sale, a product or service for sale, sales of a target customer, a sales representative, or the position of a sales representative.

In the sales assistance system according to the present example embodiment, the prediction model generation device 10 generates the graph structure data based on the activity history data, and generates the prediction model by machine learning using the graph structure data that is time-series data and the type of business of a customer that is the attribute data as inputs. The sales assistance system according to the present example embodiment predicts a sales process having a high possibility of securing a contract based on an activity history of a currently performed sales activity before the current time point in the prediction device 20 based on the generated prediction model. The sales assistance system according to the present example embodiment performs prediction by using the prediction model generated based on the graph structure data of the activity history, thereby predicting a sales process having a high possibility of securing a contract based on a similarity with a history of the currently performed sales activity. The sales assistance system according to the present example embodiment can present candidates for a future action to be performed for securing a contract after the current time point by predicting a sales process having a high possibility of securing a contract based on the similarity with the history of the currently performed sales activity. Therefore, the sales assistance system according to the present example embodiment can predict an action necessary for increasing a possibility of securing a contract in the sales activity after the current time point. As a result, the sales assistance system according to the present example embodiment can suitably support sales activities. For example, it is possible to improve a probability of success of a sales activity, increase sales, improve efficiency of the sales activity, and the like.

### Second Example Embodiment

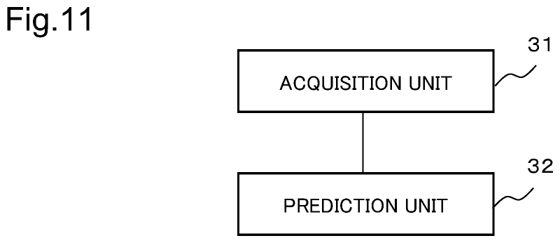

Hereinafter, a second example embodiment of the present invention will be described in detail with reference to the drawings. FIG. 11 is a diagram illustrating an outline of a configuration of a sales assistance system according to the present example embodiment. The sales assistance system according to the present example embodiment includes an acquisition unit 31 and a prediction unit 32. In the sales assistance system according to the present example embodiment, the acquisition unit 31 and the prediction unit 32 may be provided in a single device, or may be provided in different devices.

The acquisition unit 31 acquires sales process time-series data indicating a time-series order of a plurality of actions included in a sales activity for a target customer at a first time point, and customer attribute data regarding an attribute of the target customer. Specifically, the first time point refers to a time point at which an action in a sales activity and a probability of success are predicted. That is, the acquisition unit 31 acquires, as the sales process time-series data, data indicating actions included in the sales activity performed for the target customer before a prediction time point in time-series. The acquisition unit 31 is an example of an acquisition means. An example of the acquisition unit 31 is the acquisition unit 21 of the prediction device 20 according to the first example embodiment.

The prediction unit 32 predicts an action of the sales activity for the target customer after the first time point, and a probability of success of the sales activity for the target customer in a case where the action after the first time point is performed, by using a prediction model, the sales process time-series data, and the customer attribute data acquired by the acquisition unit 31. The prediction model is generated by machine learning using a plurality of pieces of sales process time-series data at time points before the first time point, a plurality of pieces of customer attribute data regarding attributes of a plurality of customers for which a sales activity related to the plurality of pieces of sales process time-series data has been performed, and a result of the sales activity for each of the plurality of customers. The prediction unit 32 is an example of a prediction means. An example of the prediction unit 32 is the prediction unit 24 of the prediction device 20 according to the first example embodiment.

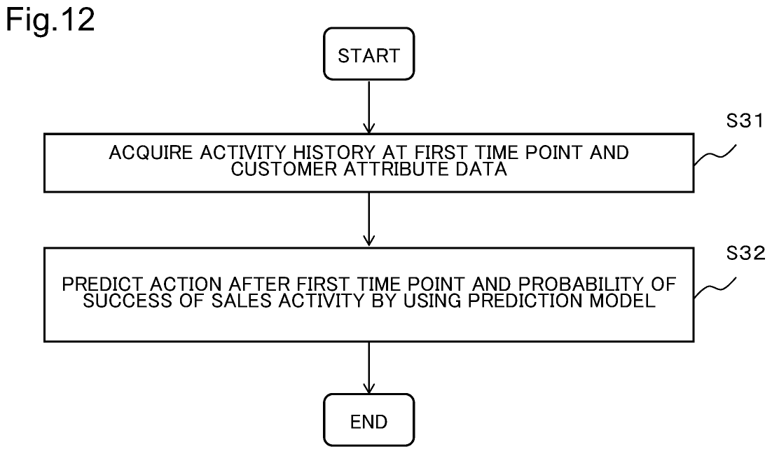

An operation of the sales assistance system according to the present example embodiment will be described. FIG. 12 is a diagram illustrating an operation flow of the sales assistance system according to the present example embodiment. First, the acquisition unit 31 acquires the sales process time-series data indicating a time-series order of a plurality of actions included in a sales activity for a target customer at the first time point, and the customer attribute data regarding an attribute of the target customer (Step S31). Specifically, the acquisition unit 31 acquires the sales process time-series data indicating the order of the actions already performed before the first time point in the sales activity in time-series, and the customer attribute data of the target customer. Once the sales process time-series data and the customer attribute data are acquired, the prediction unit 32 predicts an action of the sales activity for the target customer after the first time point, and a probability of success of the sales activity for the target customer in a case where the action after the first time point is performed, by using the prediction model, the sales process time-series data, and the customer attribute data (Step S32). Specifically, the prediction unit 32 predicts an action having a high probability of success in securing a contract for the sales activity after the first time point which is the prediction time point by using the prediction model with the sales process time-series data and the customer attribute data as inputs.

In the sales assistance system according to the present example embodiment, an activity history before the first time point which is a prediction time point and the attributes of the customer are input to the prediction model, thereby predicting an action of the sales activity after a time point at which a possibility of success in securing a contract is predicted. The prediction model is generated based on the sales process time-series data which is the activity history of the past sales activity before the first time point at which the prediction is performed and the attribute of the target customer. Therefore, the sales assistance system according to the present example embodiment can predict an action having a high probability of success of the sales activity after the prediction time point. Therefore, the sales assistance system according to the present example embodiment can predict an action necessary for increasing a possibility of securing a contract after the current time point.

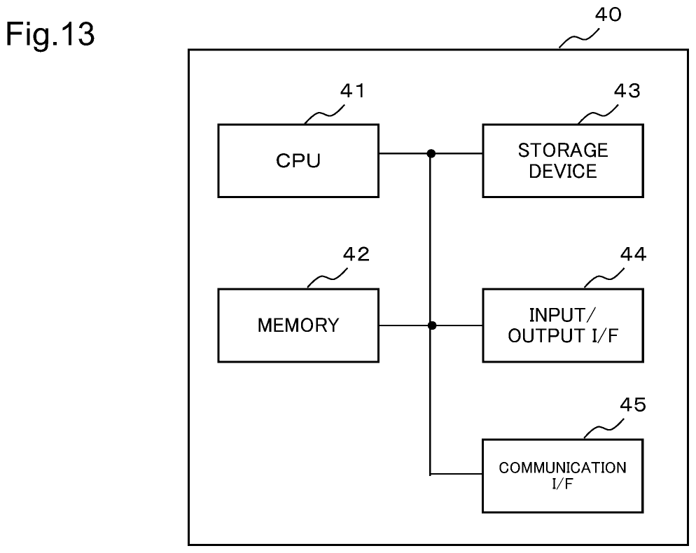

Each processing in the prediction model generation device 10 and the prediction device 20 according to the first example embodiment can be performed by executing a computer program on a computer. FIG. 13 illustrates an example of a configuration of a computer 40 that executes a computer program for performing each processing in the prediction model generation device 10 and the prediction device 20. The computer 40 includes a CPU 41, a memory 42, a storage device 43, an input/output interface (I/F) 44, and a communication I/F 45. Each processing in the sales data management server 300 according to the first example embodiment and the sales assistance system according to the second example embodiment can be similarly performed by executing a computer program on a computer such as a computer 70.

The CPU 41 reads and executes the computer program for performing each processing from the storage device 43. An arithmetic processing unit that executes the computer program may be implemented by a combination of a CPU and a GPU instead of the CPU 41. The memory 42 is implemented by a dynamic random access memory (DRAM) or the like, and temporarily stores the computer program to be executed by the CPU 41 and data being processed. The storage device 43 stores the computer program to be executed by the CPU 41. The storage device 43 is implemented by, for example, a nonvolatile semiconductor storage device. As the storage device 43, another storage device such as a hard disk drive may be used. The input/output I/F 44 is an interface that receives an input from an operator and outputs display data and the like. The communication I/F 45 is an interface that transmits and receives data to and from each device in the sales assistance system, a terminal of a user, and the like.

The computer program used for executing each processing can be stored in a recording medium and distributed. As the recording medium, for example, a magnetic tape for data recording or a magnetic disk such as a hard disk can be used. As the recording medium, an optical disk such as a compact disc read only memory (CD-ROM) can also be used. A nonvolatile semiconductor storage device may be used as the recording medium.

Some or all of the above-described example embodiments can also be described as the following Supplementary Notes, but are not limited thereto.

### [Supplementary Note 1]

A sales assistance system including:

an acquisition means configured to acquire sales process time-series data indicating a time-series order of a plurality of actions included in a sales activity for a target customer at a first time point, and customer attribute data regarding an attribute of the target customer; and

a prediction means configured to predict an action of the sales activity for the target customer after the first time point, and a probability of success of the sales activity for the target customer in a case where the action after the first time point is performed, by using a prediction model, and the sales process time-series data and the customer attribute data acquired by the acquisition means, the prediction model being generated by machine learning using a plurality of pieces of sales process time-series data at time points before the first time point, a plurality of pieces of customer attribute data regarding attributes of a plurality of customers for which a sales activity related to the plurality of pieces of sales process time-series data has been performed, and a result of the sales activity for each of the plurality of customers.

### [Supplementary Note 2]

The sales assistance system according to Supplementary Note 1, further including

a display control means configured to control a display device to display a first prediction result including the action of the sales activity for the target customer after the first time point and the probability of success of the sales activity for the target customer in a case where the action after the first time point is performed, the action and the probability of success being predicted by the prediction means.

### [Supplementary Note 3]

The sales assistance system according to Supplementary Note 2, in which

the prediction means predicts an action of the sales activity for the target customer after the first time point and a probability of success of the sales activity for the target customer in a case where the action after the first time point is performed, the action and the probability of success being different from the action and the probability of success of the first prediction result, and

the display control means controls the display device to display a second prediction result and the first prediction result, the second prediction result including the action of the sales activity for the target customer after the first time point and the probability of success of the sales activity for the target customer in a case where the action after the first time point is performed, and the action and the probability of success being different from the action and the probability of success of the first prediction result.

### [Supplementary Note 4]

The sales assistance system according to Supplementary Note 2 or 3, further including

a graph generation means configured to generate graph structure data regarding a graph including nodes indicating the plurality of actions included in the sales activity for the target customer and an edge indicating an order relation between the plurality of actions related to the nodes, the plurality of actions associated to the first prediction result,

in which the display control means controls the display device to further display a prediction result including the graph structure data generated by the graph generation means.

### [Supplementary Note 5]

The sales assistance system according to Supplementary Note 4, in which

the edge further indicates a time interval between the plurality of actions,

once a node in the graph structure data displayed on the display device is selected, the display control means controls the display device to display an action indicated by the node according to the graph structure data, and

once an edge in the graph structure data displayed on the display device is selected, the display control means controls the display device to display a time interval indicated by the edge.

### [Supplementary Note 6]

The sales assistance system according to any one of Supplementary Notes 1 to 5, further including

a prediction model generation means configured to generate the prediction model by machine learning using a plurality of pieces of sales process time-series data at time points before the first time point, a plurality of pieces of customer attribute data regarding attributes of a plurality of customers for which a sales activity related to the plurality of pieces of sales process time-series data has been performed, and a result of the sales activity for each of the plurality of customers.

### [Supplementary Note 7]

The sales assistance system according to Supplementary Note 6, in which the prediction model generation means retrains the prediction model based on the first prediction result.

### [Supplementary Note 8]

A sales assistance method including:

acquiring sales process time-series data indicating a time-series order of a plurality of actions included in a sales activity for a target customer at a first time point, and customer attribute data regarding an attribute of the target customer; and

predicting an action of the sales activity for the target customer after the first time point, and a probability of success of the sales activity for the target customer in a case where the action after the first time point is performed, by using a prediction model, and the sales process time-series data and the customer attribute data, the prediction model being generated by machine learning using a plurality of pieces of sales process time-series data at time points before the first time point, a plurality of pieces of customer attribute data regarding attributes of a plurality of customers for which a sales activity related to the plurality of pieces of sales process time-series data has been performed, and a result of the sales activity for each of the plurality of customers.

### [Supplementary Note 9]

The sales assistance method according to Supplementary Note 8, further including

controlling a display device to display a first prediction result including the action of the sales activity for the target customer after the first time point and the probability of success of the sales activity for the target customer in a case where the action after the first time point is performed, the action and the probability of success being predicted by using the prediction model.

### [Supplementary Note 10]

The sales assistance method according to Supplementary Note 9, further including:

predicting an action of the sales activity for the target customer after the first time point and a probability of success of the sales activity for the target customer in a case where the action after the first time point is performed, the action and the probability of success being different from the action and the probability of success of the first prediction result; and

controlling the display device to display a second prediction result and the first prediction result, the second prediction result including the action of the sales activity for the target customer after the first time point and the probability of success of the sales activity for the target customer in a case where the action after the first time point is performed, and the action and the probability of success being different from the action and the probability of success of the first prediction result.

### [Supplementary Note 11]

The sales assistance method according to Supplementary Note 9 or 10, further including:

generating graph structure data regarding a graph including nodes indicating the plurality of actions included in the sales activity for the target customer and an edge indicating an order relation between the plurality of actions related to the nodes, the plurality of actions associated to the first prediction result; and

controlling the display device to further display the generated graph structure data.

### [Supplementary Note 12]

The sales assistance method according to Supplementary Note 11, further including:

causing the edge to include a time interval between the plurality of actions;

once a node in the graph structure data displayed on the display device is selected, controlling the display device to display an action indicated by the node; and

once an edge in the graph structure data displayed on the display device is selected, controlling the display device to display a time interval indicated by the edge.

### [Supplementary Note 13]

The sales assistance method according to any one of Supplementary Notes 8 to 12, further including

generating the prediction model by machine learning using a plurality of pieces of sales process time-series data at time points before the first time point, a plurality of pieces of customer attribute data regarding attributes of a plurality of customers for which a sales activity related to the plurality of pieces of sales process time-series data has been performed, and a result of the sales activity for each of the plurality of customers.

### [Supplementary Note 14]

The sales assistance method according to Supplementary Note 13, further including

retraining the prediction model based on the first prediction result.

### [Supplementary Note 15]

A program recording medium recording a sales assistance program for causing a computer to perform:

processing of acquiring sales process time-series data indicating a time-series order of a plurality of actions included in a sales activity for a target customer at a first time point, and customer attribute data regarding an attribute of the target customer; and

processing of predicting an action of the sales activity for the target customer after the first time point, and a probability of success of the sales activity for the target customer in a case where the action after the first time point is performed, by using a prediction model, and the sales process time-series data and the customer attribute data, the prediction model being generated by machine learning using a plurality of pieces of sales process time-series data at time points before the first time point, a plurality of pieces of customer attribute data regarding attributes of a plurality of customers for which a sales activity related to the plurality of pieces of sales process time-series data has been performed, and a result of the sales activity for each of the plurality of customers.

The present invention has been described above using the above-described example embodiments as exemplary examples. However, the present invention is not limited to the above-described example embodiments. That is, the present invention can apply various modes that can be understood by those skilled in the art within the scope of the present invention.

### REFERENCE SIGNS LIST

10 prediction model generation device
11 acquisition unit
12 storage unit
13 graph data generation unit
14 prediction model generation unit
15 prediction model storage unit
16 prediction model output unit
20 prediction device
21 acquisition unit
22 prediction model storage unit
23 graph generation unit
24 prediction unit
25 prediction reason generation unit
26 display control unit
31 acquisition unit
32 prediction unit
40 computer
41 CPU
42 memory
43 storage device
44 input/output I/F
45 communication I/F
100 prediction system
300 sales data management server

What is claimed is:

1. A sales assistance system comprising:
at least one memory storing instructions; and
at least one processor configured to access the at least one memory and execute the instructions to:
acquire sales process time-series data indicating a time-series order of a plurality of actions included in a sales activity for a target customer at a first time point, and customer attribute data regarding an attribute of the target customer; and
predict an action of the sales activity for the target customer after the first time point, and a probability of success of the sales activity for the target customer in a case where the action after the first time point is performed, by using a prediction model, based on the sales process time-series data and the customer attribute data, wherein
the prediction model is generated by machine learning using a plurality of pieces of sales process time-series data at time points before the first time point, a plurality of pieces of customer attribute data regarding attributes of a plurality of customers for which a sales activity related to the plurality of pieces of sales process time-series data has been performed, and a result of the sales activity for each of the plurality of customers.

2. The sales assistance system according to claim 1, wherein
the at least one processor is further configured to execute the instructions to:
display a first prediction result including the predicted action of the sales activity for the target customer after the first time point and the predicted probability of success of the sales activity for the target customer in a case where the predicted action after the first time point is performed.

3. The sales assistance system according to claim 2, wherein
the at least one processor is further configured to execute the instructions to:
predict an action of the sales activity for the target customer after the first time point and a probability of success of the sales activity for the target customer in a case where the action after the first time point is performed, wherein the action and the probability of success are different from the action and the probability of success of the first prediction result; and
display a second prediction result and the first prediction result, wherein the second prediction result includes the action of the sales activity for the target customer after the first time point and the probability of success of the sales activity for the target customer in a case where the action after the first time point is performed, and wherein the action and the probability of success are different from the action and the probability of success of the first prediction result.

4. The sales assistance system according to claim 2, wherein
the at least one processor is further configured to execute the instructions to:
generate graph structure data regarding a graph including nodes indicating the plurality of actions included in the sales activity for the target customer and an edge indicating an order relation between the plurality of actions related to the nodes, the plurality of actions associated to the first prediction result;
display a prediction result including the generated graph structure data.

5. The sales assistance system according to claim 4, wherein
the edge further indicates a time interval between the plurality of actions, and wherein
the at least one processor is further configured to execute the instructions to:
in response to a selection of a node in the displayed graph structure data, display an action indicated by the selected node according to the graph structure data; and
in response to a selection of an edge in the displayed graph structure data, display a time interval indicated by the selected edge.

6. The sales assistance system according to claim 1, wherein
the at least one processor is further configured to execute the instructions to:
generate the prediction model by machine learning using a plurality of pieces of sales process time-series data at time points before the first time point, a plurality of pieces of customer attribute data regarding attributes of a plurality of customers for which a sales activity related to the plurality of pieces of sales process time-series data has been performed, and a result of the sales activity for each of the plurality of customers.

7. The sales assistance system according to claim 6, wherein
the at least one processor is further configured to execute the instructions to:
retrain the prediction model based on the first prediction result.

8. A sales assistance method comprising:
acquiring sales process time-series data indicating a time-series order of a plurality of actions included in a sales activity for a target customer at a first time point, and customer attribute data regarding an attribute of the target customer; and
predicting an action of the sales activity for the target customer after the first time point, and a probability of success of the sales activity for the target customer in a case where the action after the first time point is performed, by using a prediction model based on the sales process time-series data and the customer attribute data, wherein
the prediction model is generated by machine learning using a plurality of pieces of sales process time-series data at time points before the first time point, a plurality of pieces of customer attribute data regarding attributes of a plurality of customers for which a sales activity related to the plurality of pieces of sales process time-series data has been performed, and a result of the sales activity for each of the plurality of customers.

9. The sales assistance method according to claim 8, further comprising
displaying a first prediction result including the predicted action of the sales activity for the target customer after the first time point and the predicted probability of success of the sales activity for the target customer in a case where the predicted action after the first time point is performed.

10. The sales assistance method according to claim 9, further comprising:
predicting an action of the sales activity for the target customer after the first time point and a probability of success of the sales activity for the target customer in a case where the action after the first time point is performed, the action and the probability of success being different from the action and the probability of success of the first prediction result; and
displaying a second prediction result and the first prediction result, wherein the second prediction result includes the action of the sales activity for the target customer after the first time point and the probability of success of the sales activity for the target customer in a case where the action after the first time point is performed, and wherein the action and the probability of success are different from the action and the probability of success of the first prediction result.

11. The sales assistance method according to claim 9, further comprising:
generating graph structure data regarding a graph including nodes indicating the plurality of actions included in the sales activity for the target customer and an edge indicating an order relation between the plurality of actions related to the nodes, the plurality of actions associated to the first prediction result; and
displaying the generated graph structure data.

12. The sales assistance method according to claim 11, further comprising:
in response to a selection of a node in the displayed graph structure data displaying an action indicated by the node; and
in response to a selection of an edge in the displayed graph structure data displaying a time interval indicated by the edge, wherein
the edge includes a time interval between the plurality of actions.

13. The sales assistance method according to claim 8, further comprising
generating the prediction model by machine learning using a plurality of pieces of sales process time-series data at time points before the first time point, a plurality of pieces of customer attribute data regarding attributes of a plurality of customers for which a sales activity related to the plurality of pieces of sales process time-series data has been performed, and a result of the sales activity for each of the plurality of customers.

14. The sales assistance method according to claim 13, further comprising
retraining the prediction model based on the first prediction result.

15. A non-transitory program recording medium recording a sales assistance program for causing a computer to perform:
processing of acquiring sales process time-series data indicating a time-series order of a plurality of actions included in a sales activity for a target customer at a first time point, and customer attribute data regarding an attribute of the target customer; and
processing of predicting an action of the sales activity for the target customer after the first time point, and a probability of success of the sales activity for the target customer in a case where the action after the first time point is performed, by using a prediction model, based on the sales process time-series data and the customer attribute data, wherein
the prediction model being generated by machine learning using a plurality of pieces of sales process time-series data at time points before the first time point, a plurality of pieces of customer attribute data regarding attributes of a plurality of customers for which a sales activity related to the plurality of pieces of sales process time-series data has been performed, and a result of the sales activity for each of the plurality of customers.
